(19) United States
(12) Patent Application Publication
(10) Pub. No.: US 2026/0005297 A1
(43) Pub. Date: Jan. 1, 2026

(54) SOLID ELECTROLYTE

(71) Applicant: TOYOTA JIDOSHA KABUSHIKI KAISHA, Toyota-shi (JP)

(72) Inventor: Kazuya TAKEUCHI, Sunto-gun (JP)

(73) Assignee: TOYOTA JIDOSHA KABUSHIKI KAISHA, Toyota-shi (JP)

(21) Appl. No.: 19/092,031

(22) Filed: Mar. 27, 2025

(30) Foreign Application Priority Data
Jun. 26, 2024 (JP) 2024-102800

(51) Int. Cl. H01M 10/0564

(52) U.S. Cl. CPC H01M 10/0564; H01M 2300/0065

(57) ABSTRACT

A solid electrolyte containing a molecular crystal, and an inorganic filler, wherein: the molecular crystal contains a sulfolane-based compound, and 1,1,2,2,3,3-hexafluoropropane-1,3-disulfonimide lithium (LiCFSA) as a lithium salt; the inorganic filler is SiO₂; and assuming that a mass of the inorganic filler per g of the solid electrolyte is W (g/g_{SE}) and that a specific surface area of the inorganic filler is A (m²/g), a normalized surface area WA (m²/g_{SE}) of the inorganic filler is 15 to 900 m²/g_{SE}.

### CROSS-REFERENCE TO RELATED APPLICATION

This application claims priority to Japanese Patent Application No. 2024-102800 filed on Jun. 26, 2024. The disclosure of the above-identified application, including the specification, drawings, and claims, is incorporated by reference herein in its entirety.

### BACKGROUND

### 1. Technical Field

The disclosure relates to a solid electrolyte.

### 2. Description of Related Art

Various techniques have been proposed regarding batteries like one disclosed in Japanese Unexamined Patent Application Publication No. 2013-214510 (JP 2013-214510 A).

### SUMMARY

JP 2013-214510 A discloses a molecular crystal solid electrolyte containing an electron-donating sulfur-based organic compound and a lithium salt, but there is a room of improvement in ionic conductivity because this solid electrolyte has high crystallinity and hence has low ion mobility.

The present disclosure was devised in consideration of the circumstances, and a main object is to provide a solid electrolyte capable of improving ionic conductivity.

Specifically, the present disclosure includes the following aspects.
<1> A solid electrolyte containing a molecular crystal, and an inorganic filler, wherein:
the molecular crystal contains a sulfolane-based compound, and 1,1,2,2,3,3-hexafluoropropane-1,3-disulfonimide lithium (LiCFSA) as a lithium salt;
the inorganic filler is SiO₂; and
assuming that a mass of the inorganic filler per g of the solid electrolyte is W (g/g_{SE}) and that a specific surface area of the inorganic filler is A (m²/g), a normalized surface area WA (m²/g_{SE}) of the inorganic filler is 15 to 900 m²/g_{SE}.
<2> The solid electrolyte according to <1>, wherein a molar ratio of the sulfolane-based compound to the lithium salt contained in the molecular crystal is 2.0 or more and 3.1 or less.
<3> The solid electrolyte according to <1>or <2>, wherein a ratio of the inorganic filler contained in the solid electrolyte is 3.6 vol % to 69.4 vol %.
<4> The solid electrolyte according to any one of <1>to <3>, wherein a ratio of the inorganic filler contained in the solid electrolyte is 27.4 vol % to 60.1 vol %.
<5> A battery including the solid electrolyte according to any one of <1> to <4>.

The solid electrolyte of the present disclosure can improve ionic conductivity.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a graph illustrating the relationship between a normalized surface area WA of an inorganic filler and ionic conductivity of a solid electrolyte at room temperature (25° C.).

### DETAILED DESCRIPTION OF EMBODIMENTS

Embodiments of the present disclosure will now be described. It is noted that matters not particularly described herein but necessary for practicing the present disclosure (for example, a general structure and production process of a solid electrolyte not characterizing the present disclosure) can be understood as design matters of those skilled in the art based on related art of this field. The present disclosure can be practiced based on the contents disclosed herein and the common general technical knowledge of the field.

Herein, an average particle size of a particle is a median diameter (D50) that is a particle size corresponding to 50% cumulative in a volume-based particle size distribution measured by laser diffraction/scattering particle size distribution measurement unless otherwise stated.

### 1. Solid Electrolyte

The present disclosure provides a solid electrolyte containing a molecular crystal, and an inorganic filler, wherein:
the molecular crystal contains a sulfolane-based compound, and 1,1,2,2,3,3-hexafluoropropane-1,3-disulfonimide lithium (LiCFSA) as a lithium salt;
the inorganic filler is SiO₂; and
assuming that a mass of the inorganic filler per g of the solid electrolyte is W (g/g_{SE}) and that a specific surface area of the inorganic filler is A (m²/g), a normalized surface area WA (m²/g_{SE}) of the inorganic filler is 15 to 900 m²/g_{SE}.

The solid electrolyte of the present disclosure contains a molecular crystal and an inorganic filler.

The molecular crystal used in the present disclosure has solid-solid phase transition in the vicinity of −3° C. in addition to a melting point (solid-liquid phase transition).

By mixing the molecular crystal and the inorganic filler, the solid-solid phase transition temperature of the molecular crystal is shifted to a lower temperature side to increase the ion mobility of the molecular crystal.

The solid electrolyte of the present disclosure may be used in a battery.

The molecular crystal contains a sulfolane-based compound, and 1,1,2,2,3,3-hexafluoropropane-1,3-disulfonimide lithium (LiCFSA) as a lithium salt.

The sulfolane-based compound may be sulfolane (SL), and a derivative or the like of sulfolane.

A molar ratio of the sulfolane-based compound to the lithium salt contained in the molecular crystal may be 2.0 or more and 3.1 or less, or 2.9 or more and 3.0 or less.

The inorganic filler is SiO₂.

A ratio of the inorganic filler contained in the solid electrolyte may be 3.6 vol % to 69.4 vol %, may be 7.0 vol % or more, 13.1 vol % or more, or 27.4 vol % or more, and may be 60.1 vol % or less, 53.1 vol % or less, or 43.0 vol % or less.

A specific surface area of the inorganic filler is not especially limited, and may be 300 to 700 m²/g.

Herein, the term “specific surface area” means a BET specific surface area.

Assuming that a mass of the inorganic filler per g of the solid electrolyte is W (g/g_{SE}) and that a specific surface area of the inorganic filler is A (m²/g), a normalized surface area WA (m²/g_{SE}) of the inorganic filler is 15 to 900 m²/g_{SE}.

Normalized surface area WA (m²/g_{SE}) of inorganic filler=mass W (g/g_{SE}) of inorganic filler per g of solid electrolyte×specific surface area A (m²/g) of inorganic filler

Herein, when the normalized surface area WA (m²/g_{SE}) of the inorganic filler is 15 to 900 m²/g_{SE}, the ionic conductivity of the solid electrolyte is improved. It is presumed that when the normalized surface area WA of the inorganic filler is over 900 m²/g_{SE}, the conductivity of the solid electrolyte is reduced due to percolation loss of the molecular crystal (ionic conductive portion) caused by the inorganic filler.

### 2. Battery

A battery of the present disclosure may include the solid electrolyte of the present disclosure.

The battery of the present disclosure includes a positive electrode, an electrolyte layer, and a negative electrode in the stated order.

The battery of the present disclosure may include a positive electrode current collector, a positive electrode layer, an electrolyte layer, a negative electrode layer, and a negative electrode current collector in the stated order.

The battery of the present disclosure may include the solid electrolyte of the present disclosure in at least one layer selected from a positive electrode layer, an electrolyte layer, and a negative electrode layer.

### Positive Electrode

A positive electrode includes a positive electrode layer, and further includes a positive electrode current collector if necessary.

The positive electrode layer contains a positive electrode active material, and may contain a solid electrolyte, a conductive material, a binder, a thickener, and the like if necessary.

The positive electrode layer may be formed by applying a positive electrode slurry to at least one surface of a support such as a positive electrode current collector, and drying the resultant.

The positive electrode slurry contains a positive electrode active material, and a solvent, and may contain a solid electrolyte, a conductive material, a binder, a thickener, a solvent, and the like if necessary.

A method for applying the positive electrode slurry is not especially limited, and examples of the method include a doctor blade method, a metal mask printing method, an electrostatic coating method, a dip coating method, a spray coating method, a roll coating method, a gravure coating method, and a screen printing method.

The support is not especially limited, and those having a self-supporting property can be appropriately selected for use, and for example, a metal foil of Cu or Al can be used.

An example of the positive electrode active material includes an oxide active material. Examples of the oxide active material include LiNi_{0.8}Co_{0.15}Al_{0.05}O₂, LiCoO₂, LiMnO₂, LiNiO₂, LiVO₂, LiNi_{1/3}Co_{1/3}Mn_{1/3}O₂, LiMn₂O₄, Li(Ni_{0.5}Mn_{1.5})O₄, LiFePO₄, LiMnPO₄, LiNiPO₄, and LiCuPO₄.

The positive electrode active material may be a positive electrode active material particle.

The average particle size of the positive electrode active material particle is not especially limited, and may be 1 nm to 100 μm.

A content ratio of the positive electrode active material in the positive electrode layer is not especially limited, and may be 50.00 to 99.00 mass %.

The positive electrode active material may be coated with a lithium ion-conductive compound in at least a part of the surface thereof.

The lithium ion-conductive compound may be coated on at least a part of the surface of the positive electrode active material, or may be coated on the whole surface of the positive electrode active material.

Examples of the lithium ion-conductive compound include B₂O₃, Li₂B₄O₇, LiBPO₄, Li₃PO₄, LiPO₃, and LiNbO₃. The thickness of the coating film of the lithium ion-conductive compound is, for example, 0.1 nm or more, and may be 1 nm or more. On the other hand, the thickness of the coating film of the lithium ion-conductive compound is, for example, 100 nm or less, and may be 20 nm or less. A coating rate of the lithium ion-conductive compound coated on the positive electrode active material is, for example, 70% or more, and may be 90% or more, or 100%. A coating method of the lithium ion-conductive compound is not especially limited, and any of conventionally known methods can be appropriately employed.

The solid electrolyte used in the positive electrode layer may be the solid electrolyte of the present disclosure, and another example includes a solid electrolyte except for the solid electrolyte of the present disclosure contained in the electrolyte layer described below.

A content ratio of the solid electrolyte in the positive electrode layer is not especially limited.

Examples of the conductive material include a carbon material, a metal particle, and a conductive polymer. Examples of the carbon material include granular carbon materials such as acetylene black (AB), and Ketchen black (KB); and fibrous carbon materials such as carbon fiber, carbon nanotube (CNT), and carbon nanofiber (CNF).

A content ratio of the conductive material in the positive electrode layer is not especially limited.

Examples of the binder include an acrylonitrile-butadiene rubber (ABR), polyvinylidene fluoride (PVDF), polytetrafluoroethylene (PTFE), and a styrene-butadiene rubber (SBR).

A content ratio of the binder in the positive electrode layer is not especially limited.

Examples of the thickener include polysaccharides such as carboxymethylcellulose (CMC), and methylcellulose.

Examples of the solvent include an aqueous solvent, and an organic solvent. The aqueous solvent means water, or a mixed solvent containing water and a polar organic solvent. A solvent suitable in accordance with, for example, the positive electrode active material, the binder and the like can be selected.

As the aqueous solvent, water can be suitably used because of easiness in handling. Examples of the polar organic solvent usable in the mixed solvent include alcohols such as methanol, ethanol, and isopropyl alcohol, ketones such as acetone, and ethers such as tetrahydrofuran.

Examples of the organic solvent include 1,2,3,4-tetrahydronaphthalene, n-heptane, butyl butyrate, diisobutyl ketone, and N-methyl-2-pyrrolidone (NMP).

A material of the positive electrode current collector can be, for example, a metal such as aluminum, copper, SUS, or nickel. The thickness of the positive electrode current collector is, for example, 0.1 μm or more and 100 μm or less. The positive electrode current collector may be in the shape of a sheet or the like. The positive electrode current collector may have a structure in which a buffer layer, an elastic layer, or a positive temperature coefficient (PTC) thermistor layer is disposed on the surface thereof.

### Negative Electrode

The negative electrode includes a negative electrode layer, and further includes a negative electrode current collector if necessary.

The negative electrode layer contains a negative electrode active material. The negative electrode layer may contain at least one of a solid electrolyte, a conductive material, and a binder if necessary.

The negative electrode layer may contain, as the negative electrode active material, for example, a lithium-based active material, a carbon-based active material, an oxide-based active material, a Si-based active material, or the like.

Examples of the lithium-based active material include metal lithium, and a lithium alloy. Examples of a metal element contained in a lithium alloy in addition to lithium include Mg, Ag, In, Sn, Si, Ga, Au, and Pt.

Examples of the carbon-based active material include graphite, hard carbon, and soft carbon.

An example of the oxide-based active material includes lithium titanate.

Examples of the Si-based active material include simple Si, a Si alloy, and silicon oxide.

The negative electrode active material is in the shape of, for example, a particle. An average particle size of a negative electrode active material particle is not especially limited, and may be 1 nm to 100 μm.

The solid electrolyte used in the negative electrode layer may be the solid electrolyte of the present disclosure, and another example includes a solid electrolyte except for the solid electrolyte of the present disclosure contained in the electrolyte layer described below.

Examples of the conductive material, and the binder used in the negative electrode layer include those exemplified above as the conductive material and the binder contained in the positive electrode layer.

The thickness of the negative electrode layer may be 0.1 μm or more, and may be 100 μm or less.

Examples of a material of the negative electrode current collect include SUS, aluminum, copper, nickel, iron, titanium, and carbon. The negative electrode current collector can be in the shape of, for example, a foil, a plate, or the like. The planar view shape of the negative electrode current collector is not especially limited, and examples include circular, elliptic, rectangular, and any polygonal shapes. The thickness of the negative electrode current collector varies depending on the shape, and may be, for example, in a range of from 1 μm to 50 μm, and may be in a range of from 5 μm to 20 μm. The negative electrode current collector may have a structure in which a buffer layer, an elastic layer, or a positive temperature coefficient (PTC) thermistor layer is disposed on the surface thereof.

### Electrolyte Layer

The electrolyte layer contains at least an electrolyte.

The electrolyte may be an electrolytic solution, or may be a solid electrolyte.

The solid electrolyte contained in the electrolyte layer may be the solid electrolyte of the present disclosure, and alternatively, may be a sulfide solid electrolyte, an oxide solid electrolyte, a halide solid electrolyte, or the like.

Examples of the sulfide solid electrolyte include solid electrolytes containing a Li element, an M element (wherein M is at least one of P, As, Sb, Si, Ge, Sn, B, Al, Ga, and In), and a S element. Besides, the sulfide solid electrolyte may further contain at least one of an O element and a halogen element.

Examples of the sulfide solid electrolyte include Li₂S—P₂S₅, Li₂S—SiS₂, LiX—Li₂S—SiS₂, LiX—Li₂S—P₂S₅, LiX—Li₂O—Li₂S—P₂S₅, LiX—Li₂S—P₂O₅, LiX—Li₃PO₄—P₂S₅, and Li₃PS₄. It is noted that the expression “Li₂S—P₂S₅” means a material using raw material compositions containing Li₂S and P₂S₅, and the other expressions are also similarly defined.

Besides, “X” in the LiX refers to a halogen element. Examples of the halogen element include a F element, a Cl element, a Br element, and an I element. One or more LiXs may be contained in a raw material composition containing the LiX. When two or more LiXs are contained, a mixing ratio of the two or more LiXs is not especially limited.

A molar ratio of the respective elements in the sulfide solid electrolyte can be controlled by adjusting the contents of the respective elements in a raw material. Besides, a molar ratio and compositions of the respective elements in the sulfide solid electrolyte can be measured by, for example, ICP atomic emission spectroscopy.

An example of the oxide solid electrolyte includes a substance having a garnet-type crystal structure containing a Li element, a La element, an A element (wherein A is at least one of Zr, Nb, Ta, and Al), and an O element. The oxide solid electrolyte may be, for example, Li₂O—B₂O₃—P₂O₅, Li₂O—SiO₂, Li₂O—B₂O₃, Li_{1.3}Al_{0.3}Ti_{0.7}(PO₄)₃, Li₅La₃Ta₂O₁₂, Li₇La₃Zr₂O₁₂, Li₆BaLa₂Ta₂O₁₂, Li_{3.6}Si_{0.6}P_{0.4}O₄, Li₄SiO₄, Li₃PO₄,Li₃₊ₓPO₄₋ₓNₓ (1≤x≤3) or the like.

The halide solid electrolyte may be, for example, a solid electrolyte containing Li, M, and X (wherein M represents at least one of Ti, Al, and Y, and X represents F, Cl, or Br).

The solid electrolyte may be in the shape of a particle from the viewpoint of good handleability.

The average particle size (D50) of a particle of the solid electrolyte is not especially limited, and may be 1 nm to 100 μm.

Single one of, or two or more of solid electrolytes can be used. Besides, when two or more solid electrolytes are used, the two or more solid electrolytes may be mixed, or layers of the respective two or more solid electrolytes may be formed to obtain a multilayer structure.

A ratio of the solid electrolyte in the electrolyte layer is not especially limited, and is, for example, 50 mass % or more, may be in a range of 60 mass % or more and 100 mass % or less, may be in a range of 70 mass % or more and 100 mass % or less, or may be 100 mass %. The solid electrolyte may contain an electrolytic solution in an amount of less than 10 mass % based on the entire electrolyte. It is noted that the solid electrolyte may be a composite solid electrolyte containing an inorganic solid electrolyte and a polymer electrolyte.

When the electrolyte layer is a solid electrolyte layer, the solid electrolyte layer contains a solid electrolyte, and further contains a binder and the like if necessary.

Examples of the binder include those exemplified above as the binder that can be contained in the positive electrode layer.

When the solid electrolyte layer contains a binder, the content of the binder may be 0 mass % to 10 mass % based on the total amount of the solid electrolyte layer.

The thickness of the solid electrolyte layer is not especially limited, and may be, for example, 1 μm or more, and may be 100 μm or less from the viewpoint of reduction of the resistance of the battery.

The type of the battery is not especially limited, and an example includes a lithium ion battery. The battery may be a primary battery, or a secondary battery. The battery may be a solid state battery.

Herein, the term “solid state battery” means a battery containing a solid electrolyte. The solid state battery may be a semi-solid state battery containing a solid electrolyte and a liquid material, or may be an all-solid state battery containing no liquid material. The shape of the battery is not especially limited, and the battery may be, for example, a coin-shaped, cylindrical, square, sheet-shaped, button-shaped, flat, or stacked battery.

The battery is used as, for example, a power source of vehicles such as a hybrid electric vehicle (HEV), a plug-in hybrid electric vehicle (PHEV), a battery electric vehicle (BEV), a gasoline vehicle, or a diesel vehicle. In particular, the battery may be used as a power source for driving a hybrid vehicle (HEV), a plug-in hybrid electric vehicle (PHEV), or a battery electric vehicle (BEV). Alternatively, the battery may be used as a power source for mobile objects except for vehicles (such as a train, a ship, and an aircraft), or may be used as a power source of electric products such as an information processor.

### Examples 1 to 30, and Comparative Example 1 to 10

### Preparation of Inorganic Filler

Four inorganic fillers 1 to 4 shown in Table 1 were prepared.

In each of Examples 1 to 30, and Comparative Examples 2, and 4 to 10, any one of the inorganic fillers 1 to 4 was used as shown in Tables 2 to 3. In Comparative Examples 1 and 3, no inorganic filler was used.

TABLE 1

| | Inorganic Filler 1 | Inorganic Filler 2 | Inorganic Filler 3 | Inorganic Filler 4 |
|---|---|---|---|---|
| Material | SiO₂ | SiO₂ | SiO₂ | SiO₂ |
| Manufacturer | Nippon Aerosil | Strem Catalog | Strem Catalog | Sigma Aldrich |
| Model No. | AEROSIL 300 | KCC-1 M2 | KCC-1 L1 | SBA-15 |
| Specific Gravity | 2.2 | 2.2 | 2.2 | 2.2 |
| [g/cc] | | | | |
| Specific Surface | 300 | 600 | 700 | 700 |
| Area [m²/g] | | | | |
| Shape | Sphere | Fibrous Particle | Fibrous Particle | Mesoporous |
| | | | | Particle |

### Synthesis of Molecular Crystal

Experiments were all performed at a temperature equal to a dewpoint of −80° C. or lower in a glove box in an Ar atmosphere at an oxygen concentration lower than 3 ppm, or in equivalent environment not exposed to the air.

In each of Examples and Comparative Examples, LiCFSA was added as a lithium salt in an amount shown in Tables 2 to 3 to sulfolane (SL) having been melted by heating to 60° C., and the resultant was stirred under heating to dissolve the lithium salt. After the dissolution, the melt was stirred for 2 hours, and then cooled to room temperature, and thus, a molecular crystal was synthesized.

In each of Examples 1 to 11, 20 to 30, and Comparative Examples 1, 2, and 5 to 10, a molecular crystal in which the molar ratio of SL to LiCFSA contained in the molecular crystal was 3 (SL:LiCFSA=3:1) was obtained.

In each of Examples 12 to 19, and Comparative Examples 3 and 4, a molecular crystal in which the molar ratio of SL to LiCFSA contained in the molecular crystal was 2.9 (SL:LiCFSA=2.9:1) was obtained.

### Preparation of Solid Electrolyte

In each of Examples 1 to 30 and Comparative Examples 2, and 4 to 10, the synthesized molecular crystal, and an inorganic filler shown in Table 2 or 3 selected from the inorganic fillers 1 to 4 shown in Table 1 were weighed to a volume ratio shown in Table 2 or 3 in the resultant solid electrolyte for compositing the SL/LiCFSA molecular crystal in a molten state and the inorganic filler. The thus obtained composite was evaluated as the solid electrolyte. A normalized surface area WA (m²/g_{SE}) of the inorganic filler per g of the solid electrolyte was calculated. The results are shown in Tables 2 to 3.

In Comparative Example 1, the molecular crystal in which the molar ratio of SL to LiCFSA contained in the molecular crystal was 3 (SL:LiCFSA=3:1) was evaluated as the solid electrolyte.

In Comparative Example 3, the molecular crystal in which the molar ratio of SL to LiCFSA contained in the molecular crystal was 2.9 (SL:LiCFSA=2.9:1) was evaluated as the solid electrolyte.

### Measurement of Ionic Conductivity

In each of Examples and Comparative Examples, 50 mg of the solid electrolyte was put in a cylinder having a diameter of 11. 28 mm (1 cm²), and the resultant was press-molded to obtain a solid electrolyte layer. On both sides of the solid electrolyte layer, carbon-coated aluminum foils were disposed for current collection to produce an evaluation cell. The evaluation cell was measured for alternating current impedance under measurement conditions of a temperature of 25° C., an amplitude of 10 mV, and a frequency of 1 MHz to 10 mHz. Thus, a resistance value of the solid electrolyte caused by ionic conduction was obtained, and the ionic conductivity of the solid electrolyte was calculated based on the cell shape. The results are shown in Tables 2 to 3.

TABLE 2

| | | | | Inorganic | | | |
|---|---|---|---|---|---|---|---|
| | | | Inorganic | Filler | Inorganic | Inorganic | Solid |
| | Molecular | | Filler | Specific | Filler | Filler | Electrolyte |
| | Crystal | | Specific | Surface | Volume | Normalized | Ionic |
| | SL/LiCFSA = | | Gravity | Area | Ratio | Surface Area | Conductivity |
| | x/1 | Inorganic Filler | [g/cc] | [m²/g] | [vol. %] | [m²/g_{SE}] | [S/cm@25° C.] |
| Comparative | 3 | none | — | — | 0 | 0 | 7.6 × 10⁻⁷ |
| Example 1 | | | | | | | |
| Example 1 | 3 | SiO₂ (AEROSIL 300) | 2.2 | 300 | 3.6 | 15 | 2.2 × 10⁻⁶ |
| Example 2 | 3 | SiO₂ (AEROSIL 300) | 2.2 | 300 | 7.0 | 30 | 3.5 × 10⁻⁶ |
| Example 3 | 3 | SiO₂ (AEROSIL 300) | 2.2 | 300 | 13.1 | 60 | 5.5 × 10⁻⁶ |
| Example 4 | 3 | SiO₂ (AEROSIL 300) | 2.2 | 300 | 18.5 | 90 | 7.1 × 10⁻⁶ |
| Example 5 | 3 | SiO₂ (AEROSIL 300) | 2.2 | 300 | 23.2 | 120 | 9.5 × 10⁻⁶ |
| Example 6 | 3 | SiO₂ (AEROSIL 300) | 2.2 | 300 | 27.4 | 150 | 1.3 × 10⁻⁵ |
| Example 7 | 3 | SiO₂ (AEROSIL 300) | 2.2 | 300 | 37.6 | 240 | 2.6 × 10⁻⁵ |
| Example 8 | 3 | SiO₂ (AEROSIL 300) | 2.2 | 300 | 43.0 | 300 | 2.7 × 10⁻⁵ |
| Example 9 | 3 | SiO₂ (AEROSIL 300) | 2.2 | 300 | 53.1 | 450 | 1.9 × 10⁻⁵ |
| Example 10 | 3 | SiO₂ (AEROSIL 300) | 2.2 | 300 | 60.1 | 600 | 1.0 × 10⁻⁵ |
| Example 11 | 3 | SiO₂ (AEROSIL 300) | 2.2 | 300 | 69.4 | 900 | 2.6 × 10⁻⁶ |
| Comparative | 3 | SiO₂ (AEROSIL 300) | 2.2 | 300 | 75.1 | 1200 | 7.4 × 10⁻⁷ |
| Example 2 | | | | | | | |
| Comparative | 2.9 | none | — | — | 0 | 0 | 2.4 × 10⁻⁶ |
| Example 3 | | | | | | | |
| Example 12 | 2.9 | SiO₂ (AEROSIL 300) | 2.2 | 300 | 3.6 | 15 | 2.5 × 10⁻⁶ |
| Example 13 | 2.9 | SiO₂ (AEROSIL 300) | 2.2 | 300 | 7.0 | 30 | 3.1 × 10⁻⁶ |
| Example 14 | 2.9 | SiO₂ (AEROSIL 300) | 2.2 | 300 | 13.1 | 60 | 4.4 × 10⁻⁶ |
| Example 15 | 2.9 | SiO₂ (AEROSIL 300) | 2.2 | 300 | 37.6 | 240 | 2.3 × 10⁻⁵ |
| Example 16 | 2.9 | SiO₂ (AEROSIL 300) | 2.2 | 300 | 43.0 | 300 | 3.1 × 10⁻⁵ |
| Example 17 | 2.9 | SiO₂ (AEROSIL 300) | 2.2 | 300 | 53.1 | 450 | 1.6 × 10⁻⁵ |
| Example 18 | 2.9 | SiO₂ (AEROSIL 300) | 2.2 | 300 | 60.1 | 600 | 8.9 × 10⁻⁶ |
| Example 19 | 2.9 | SiO₂ (AEROSIL 300) | 2.2 | 300 | 69.4 | 900 | 2.5 × 10⁻⁶ |
| Comparative | 2.9 | SiO₂ (AEROSIL 300) | 2.2 | 300 | 75.1 | 1200 | 6.4 × 10⁻⁷ |
| Example 4 | | | | | | | |

TABLE 3

| | | | | Inorganic | | | |
|---|---|---|---|---|---|---|---|
| | | | Inorganic | Filler | Inorganic | Inorganic | Solid |
| | Molecular | | Filler | Specific | Filler | Filler | Electrolyte |
| | Crystal | | Specific | Surface | Volume | Normalized | Ionic |
| | SL/LiCFSA = | | Gravity | Area | Ratio | Surface Area | Conductivity |
| | x/1 | Inorganic Filler | [g/cc] | [m²/g) | [vol. %] | [m²/g_{SE}] | [S/cm@25° C.] |
| Example 20 | 3 | SiO₂ (KCC-1 M2) | 2.2 | 600 | 7.0 | 60 | 2.4 × 10⁻⁶ |
| Example 21 | 3 | SiO₂ (KCC-1 M2) | 2.2 | 600 | 27.4 | 300 | 4.6 × 10⁻⁶ |
| Example 22 | 3 | SiO₂ (KCC-1 M2) | 2.2 | 600 | 43.0 | 600 | 4.5 × 10⁻⁶ |
| Comparative | 3 | SiO₂ (KCC-1 M2) | 2.2 | 600 | 60.1 | 1200 | 4.6 × 10⁻⁷ |
| Example 5 | | | | | | | |
| Comparative | 3 | SiO₂ (KCC-1 M2) | 2.2 | 600 | 69.4 | 1800 | 8.5 × 10⁻⁸ |
| Example 6 | | | | | | | |
| Example 23 | 3 | SiO₂ (KCC-1 L1) | 2.2 | 700 | 7.0 | 90 | 2.4 × 10⁻⁶ |
| Example 24 | 3 | SiO₂ (KCC-1 L1) | 2.2 | 700 | 27.4 | 350 | 4.1 × 10⁻⁶ |
| Example 25 | 3 | SiO₂ (KCC-1 L1) | 2.2 | 700 | 43.0 | 700 | 2.2 × 10⁻⁶ |
| Comparative | 3 | SiO₂ (KCC-1 L1) | 2.2 | 700 | 60.1 | 1400 | 1.5 × 10⁻⁷ |
| Example 7 | | | | | | | |
| Comparative | 3 | SiO₂ (KCC-1 L1) | 2.2 | 700 | 69.4 | 2100 | 2.1 × 10⁻⁸ |
| Example 8 | | | | | | | |
| Example 26 | 3 | SiO₂ (SBA-15) | 2.2 | 700 | 7.0 | 70 | 5.4 × 10⁻⁶ |
| Example 27 | 3 | SiO₂ (SBA-15) | 2.2 | 700 | 10.2 | 105 | 8.3 × 10⁻⁶ |
| Example 28 | 3 | SiO₂ (SBA-15) | 2.2 | 700 | 17.4 | 196 | 2.0 × 10⁻⁵ |
| Example 29 | 3 | SiO₂ (SBA-15) | 2.2 | 700 | 27.4 | 350 | 2.4 × 10⁻⁶ |
| Example 30 | 3 | SiO₂ (SBA-15) | 2.2 | 700 | 43.0 | 700 | 8.4 × 10⁻⁶ |
| Comparative | 3 | SiO₂ (SBA-15) | 2.2 | 700 | 60.1 | 1400 | 2.0 × 10⁻⁶ |
| Example 9 | | | | | | | |
| Comparative | 3 | SiO₂ (SBA-15) | 2.2 | 700 | 69.4 | 2100 | 3.4 × 10⁻⁷ |
| Example 10 | | | | | | | |

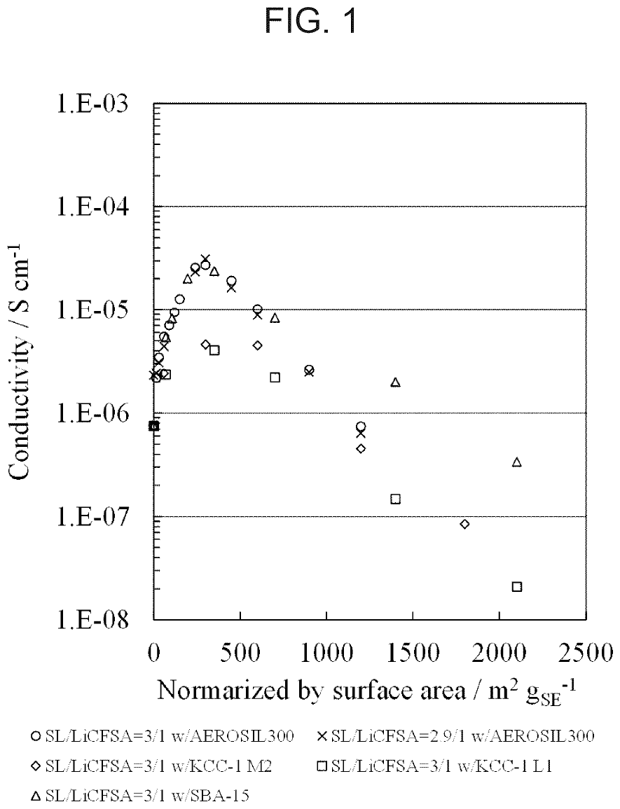

FIG. 1 is a graph illustrating the relationship between a normalized surface area WA of the inorganic filler and ionic conductivity of the solid electrolyte at room temperature (25° C.).

As shown in Table 2, it is understood that the ionic conductivity is improved in Examples 1 to 11 as compared with that in Comparative Examples 1 and 2.

As shown in Table 2, it is understood that the ionic conductivity is improved in Examples 12 to 19 as compared with that in Comparative Examples 3 and 4.

As shown in Table 3, it is understood that the ionic conductivity is improved in Examples 20 to 22 as compared with that in Comparative Examples 5 to 6.

As shown in Table 3, it is understood that the ionic conductivity is improved in Examples 23 to 25 as compared with that in Comparative Examples 7 to 8.

As shown in Table 3, it is understood that the ionic conductivity is improved in Examples 26 to 30 as compared with that in Comparative Examples 9 to 10.

As shown in FIG. 1 and Tables 2 to 3, it is understood that the ionic conductivity is improved in Examples 1 to 30 as compared with that in Comparative Examples 1 to 10.

In this manner, it was verified that a solid electrolyte satisfying a condition that the normalized surface area WA (m²/g_{SE}) of an inorganic filler is 15 to 900 m²/g_{SE} can improve the ionic conductivity as compared with a solid electrolyte not satisfying the condition.

What is claimed is:

1. A solid electrolyte comprising a molecular crystal, and an inorganic filler, wherein:
the molecular crystal comprises a sulfolane-based compound, and 1,1,2,2,3,3-hexafluoropropane-1,3-disulfonimide lithium (LiCFSA) as a lithium salt;
the inorganic filler is SiO₂; and
assuming that a mass of the inorganic filler per g of the solid electrolyte is W (g/g_{SE}) and that a specific surface area of the inorganic filler is A (m²/g), a normalized surface area WA (m²/g_{SE}) of the inorganic filler is 15 to 900 m²/g_{SE}.

2. The solid electrolyte according to claim 1, wherein a molar ratio of the sulfolane-based compound to the lithium salt comprised in the molecular crystal is 2.0 or more and 3.1 or less.

3. The solid electrolyte according to claim 1, wherein a ratio of the inorganic filler comprised in the solid electrolyte is 3.6 vol % to 69.4 vol %.

4. The solid electrolyte according to claim 1, wherein a ratio of the inorganic filler comprised in the solid electrolyte is 27.4 vol % to 60.1 vol %.

5. A battery comprising the solid electrolyte according to claim 1.
